(19) United States
(12) Patent Application Publication
(10) Pub. No.: US 2025/0299235 A1
(43) Pub. Date: Sep. 25, 2025

(54) MEDICINE MARKETPLACE SYSTEM

(71) Applicant: SAP SE, Walldorf (DE)

(72) Inventors: Savan RAI, Bangalore (IN); Vinutha Yediyur VARADARAJAIYENGAR, Bangalore (IN); Arun Mysore CHAMARAJU, Bangalore (IN)

(21) Appl. No.: 18/613,220

(22) Filed: Mar. 22, 2024

(51) Int. Cl. G06Q 30/0601

(52) U.S. Cl. CPC G06Q 30/0607; G06Q 30/0613

(57) ABSTRACT

System, method, and various embodiments for a medicine marketplace system are described herein. An embodiment operates by detecting that a requester has submitted a request for medicine. It is determined that a first threshold has been crossed prior to an expiration date of the medicine corresponding to a provider. A first notification is provided to the provider indicating that the first threshold has been crossed. An acknowledgement to make the medicine available for transfer to the requester is received. A transaction to transfer the medicine from the provider to the requester prior to the expiration date is consummated.

### BACKGROUND

A pharmacy may estimate what customer demand is likely to be for various medicines, and based on these estimations, the pharmacy may then order medicines in bulk to serve their patients or customers. However, ordering medicines in this manner is an inaccurate process that often results in some pharmacies ordering too much medicine, medicine which is wasted if it unused or unsold prior to the expiration date, while other pharmacies do not order enough medicine or have access to enough medicine to serve their patients, and their patients are left to suffer without access to the proper medicines.

### BRIEF DESCRIPTION OF THE DRAWINGS

The accompanying drawings are incorporated herein and form a part of the specification.

FIG. 1 is a block diagram illustrating example functionality for a medicine marketplace system (MMS), according to some embodiments.

FIG. 2 is a flowchart illustrating example operations for providing a medicine marketplace system (MMS), according to some embodiments.

FIG. 3 is example computer system useful for implementing various embodiments.

FIG. 4 is another block diagram illustrating example functionality for a medicine marketplace system (MMS), according to some embodiments.

FIG. 5 is a sequence diagram illustrating example functionality for a medicine marketplace system (MMS), according to some embodiments.

FIG. 6 is a sequence diagram illustrating example functionality for a medicine marketplace system (MMS), according to some embodiments.

FIGS. 7A-7B are an example screens illustrating example functionality for a marketplace interface of a medicine marketplace system (MMS), according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a medicine marketplace system.

A pharmacy may estimate what customer demand is likely to be for various medicines, and based on these estimations, the pharmacy may then order medicines in bulk to serve their patients or customers. However, ordering medicines in this manner is an inaccurate process that often results in some pharmacies ordering too much medicine, medicine which is wasted if it unused or unsold prior to the expiration date, while other pharmacies do not order enough medicine or have access to enough medicine to serve their patients, and their patients are left to suffer without access to the proper medicines.

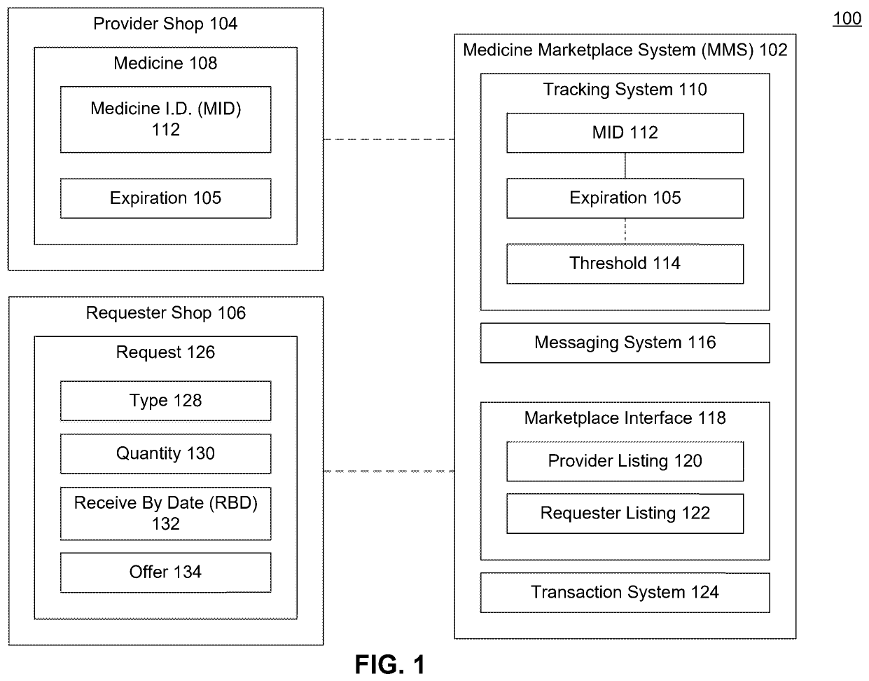

FIG. 1 is a block diagram 100 illustrating example functionality for a medicine marketplace system (MMS) 102, according to some embodiments. MMS 102 may allow for a more efficient use of expiring raw materials, such as medicine 108, for the benefit of everyone. For example, if a provider shop 104 orders more medicine 108 than they can use by the expiration date 105 (of the medicine 108), MMS 102 may facilitate and allow the provider 104 to resell or donate the medicine 108 to a requester shop 106 that is in need of the medicine 108, rather than allowing the medicine 108 to expire and simply go to waste in the inventory of the provider 104. In some embodiments, a tracking system 110 may track the movements of the medicine 108 to help ensure the authenticity of medicine 108 that is being delivered from the provider 104 to the requester 106.

In some embodiments, MMS 102 may help provider 104 offset the costs of ordering too much medicine 108 by providing a secondary market for the excess medicine which can be resold or donated to a requester 106 in need of the medicine 108.

While many of the examples described herein focus primarily on the exchange of medicine 108, it is understood that the MMS 102 may be beneficial in the exchange of any materials, supplies, nutrients, vitamins, fruits, vegetables, animal products, untreated lumber, chemicals, or any other products with an expiration date or use by date, after which the usability or effectiveness of the materials or products likely diminishes or begins to diminish. Medicine 108 may also include to any raw materials or supplies that are used for any purpose, including but not limited to the making of medicine 108, food products, or other compounds.

MMS 102 may help increase commerce, increase profitability, reduce waste, reduce costs, and improve the lives of individuals in need by providing a secondary marketplace where expiring materials (referred to herein as medicine 108) can be exchanged between a providing shop (provider) 104, and a requesting shop (requester) 106, prior to the expiration date 105 of the materials, benefitting both parties in the exchange, and society at large.

In some embodiments, provider 104 may receive a shipment of medicine 108 from a manufacturer, supplier, or distributor (not shown), herein referred to generally as supplier. Tracking system 110 may receive information directly from the supplier to the track the movements and authenticity of the medicine when the medicine is transferred or allocated to be transferred to a provider 104. In some embodiments, tracking system 110 may receiving information such as a medicine ID (MID) 112 and expiration date 105 from the supplier. In some embodiments, other information may be received as well such as quantity, date of shipment, shipping company, method of shipping, etc. In some embodiments, this information may be received from the shipping company and/or the provider 104. For example, provider 104 may type in the details of the medicine 108, take a picture of a barcode or packaging, and tracking system 110 may store and/or verify the provided information matches any information received by tracking system 110 from the supplier.

MID 112 may include any unique identifying information regarding the medicine 108 (or other raw material) that was received by or shipped to provider shop 104. For example, MID 112 may include a make and model number, batch number, serial number, barcode, authentication code, name, location from which the material was produced or extracted, description, and/or any other unique identifying information that may be help distinguish one batch of medicine 108 from another. In some embodiments, a supplier may generate millions of batches of medicine, and each batch may be identified by a unique batch number. This unique batch number may be used as MID 112. Each batch may include multiple packages of medicine which may be individually sold or distributed.

Tracking system 110 may also receive or identify expiration 105. Expiration 105 may include a date by which the medicine 108 (or other material) is best used by, or after which the medicine 108 should no longer be used. In some embodiments, the expiration 105 may be a date after which the effectiveness of the medicine 108 for particular purposes reduces, or the medicine 108 is spoiled and should be discarded and no longer used or sold. In some embodiments, expiration 105 may be a sell-by date or best-used-by date.

In some embodiments, provider 104 may receive the actual physical medicine 108, as identified by MID 112 and with its expiration date 105. The medicine 108 may be received at a warehouse or storefront and logged into an inventory system (not shown) of provider 104. In some embodiments, tracking system 110 may track details that the supplier sent the medicine 108 to provider 104, the quantity of the medicine, the MID 112, and the expiration 105. In some embodiments, provider 104 may confirm or log what medicine 108 was received, its MID 112, expiration, quantity, date of receipt, and other information into tracking system 110 which may be accessible via one or more computing devices at provider 104. For example, messaging system 116 may send a message to provider 104 requesting confirmation of the receipt of medicine 108 from one or more suppliers.

During its normal business operations, provider 104 may distribute portions of the received quantity of medicine 108 to customers or otherwise allocate the medicine 108 for other uses. In some embodiments, MMS 102 may be communicatively coupled to a point-of-sale or inventory tracking system at provider 104, such that with each sale, use, or distribution of medicine 108, the quantity of medicine 108 available or remaining at provider 104 (which may be tracked by tracking system 110) is updated accordingly. In some embodiments, the quantity of available or remaining medicine 108 may be updated or synchronized in real-time, or periodically (e.g., weekly, monthly, etc.) during off-peak hours so as to not interfere with normal business operations of provider 104.

In some embodiments, tracking system 110 may track the expiration dates 105 of medicine 108 distributed to or received by provider 104. For simplicity, only a single medicine 108 and single provider 104 are illustrated, however it is understood that in some embodiments, multiple different types of medicines 108 (or other materials), each with its own unique expiration 105, may be tracked across multiple different providers 104.

In some embodiments, tracking system 110 may register or track one or more thresholds 114 for each medicine 108. A threshold 114 may be different from an expiration 105. Threshold 114 may indicate a date by which some action is performed or recommended to be taken with regards to the use or re-distribution of the medicine 108, and may occur prior to the expiration 105.

For example, a first threshold 114 may be for an initial listing of medicine 108 with MMS 102 or resale or distribution, and the first threshold 114 may be for three months prior to the expiration date 105. For example, if the expiration date 105 is June 9^{th}, and the first threshold 114 of three months, would be March 9^{th}. Then for example, on or before March 9^{th} messaging system 116 may transmit an electronic message to provider 104 requesting authorization to list medicine 108 for resale via MMS 102. Provider 104 may then reject or authorize the sale or distribution of a specified amount or quantity of medicine 108.

In some embodiments, MMS 102 may automatically generate a provider listing 120 for the tracked remaining quantity of medicine 108, on the expiration of the first threshold 114 at a pre-determined price. Messaging system 116 may notify provider 104 of the listing and give provider 104 the option of changing or removing the provider listing 120.

Messaging system 116 may include any system capable of sending or receiving electronic communications or messaging, such as automated phone calls, emails, text messages, instant messages, etc. In some embodiments, the provider 104 may receive the message via a mobile device, tablet, point-of-sale device, inventory tracking system, or other computing system. In some embodiments, the messaging may occur via an app or program installed on one or more computing devices at provider 104, or through the inventory system. In some embodiments, this message may include details about the medicine 108 such as MID 112, expiration 105, and quantity. The message may include other information such as supplier, and when it was received, and the quantity received by provider, etc. In some embodiments, the message may include a version or preview of the provider listing 120 which may be edited by provider 104 prior to or after activating the listing.

In some embodiments, a user at provider 104 may authorize to list the medicine 108 identified by MID 112 for resale, and may indicate a quantity to be resold and a price of resale. In some embodiments, MMS 102 may recommend a price for reselling medicine 108 based on historical transaction data and/or current demand (e.g., other requesters 106 who may have requested medicine 108 at a particular price and/or quantity). Often times the resell price may be lower than the original purchase price by provider 104 because of the impending expiration 105, but reselling the medicine may help provider 104 recoup some of the purchase costs.

In some embodiments, after the first threshold 114, MMS 102 may identify any requester listings 122 for medicine 108 and provide one or more of the listings to provider 104 in requesting a transfer or sale of at least a portion remaining quantity of medicine 108. In some embodiments, the identified requester listing(s) 122 may be the basis for recommending a list or resale price of the medicine 108. In some embodiments, this message to provider 104 may include an option to transfer at least a portion of the remaining medicine 108 to one or more of the pre-identified requesters 106.

In some embodiments, MMS 102 may allow provider 104 to distribute or transact to distribute certain quantities of medicine 108 to any identified requesters 106, prior to listing the medicine 108 for distribution via a marketplace interface 118. Then, for example, for any remaining or excess quantities of medicine 108, after the initial distribution to outstanding requesters 106, MMS 102 may generate a provider listing 120 for any future or prospective requesters 106 to see or bid upon via the marketplace interface 118.

Upon receiving authorization from provider 104 to make available a specific quantity of medicine 108, MMS 102 via messaging system 116 may notify any requesters 106 who are seeking the medicine 108 (or its equivalent) that the medicine 108 in the specified quantity is available at the (discounted) price. A requester 106 may confirm their interest in the medicine, and a transaction system 124 may consummate a sales transaction between provider 104 and requester 106, in any suitable manner as performed by an electronic marketplace. Upon successful delivery or transfer of the medicine 108 to requester 106, tracking system 110 may update the information related to medicine 108. In some embodiments, transaction system 124 may receive payment from a requester 106, and transfer the payment (or a portion of the payment less a transaction or other fee) to provider 104 as part of consummating the transaction.

In some embodiments, tracking system 110 may include multiple thresholds 114. As noted above, the first threshold 114 may be an initial listing threshold at a first price. If the medicine 108 has not been fully distributed by a subsequent threshold, messaging system 116 may send one or more additional messages to provider 104 recommending to further reduce the price and/or to donate the medicine 108. In some embodiments, MMS 102 may be pre-authorized to reduce the price if medicine 108 has been unsold by a particular date and/or if a threshold quantity is remaining.

In the examples described herein, MMS 102, via messaging system 116, may initiate the listing and distribution of medicine 108 from provider 104, however in other embodiments, provider 104 may initiate re-selling or distributing medicine 108 at any time prior to expiration 105.

In some embodiments, tracking system 110 may include a donation threshold 114. The donation threshold 114 may indicate a date by which the medicine 108 is recommended to be donated to a low-income or impoverished requester 106 in need, rather than being discarded at expiration 105. In some embodiments, tracking system 110 may include both a resale and donation threshold 114. For example, if the resale threshold is 3 months, the donation threshold may be 6 weeks prior to expiration 105.

A donation message may be sent by messaging system 116 recommending the donation of any remaining quantities of medicine 108 prior to the impending expiration 105. In some embodiments, provider 104 may be able to enter the amount of remaining medicine 108 to be donated, and MMS 102 could arrange for distributing the medicine 108 to the appropriate requester(s) 106 for donation. In some embodiments, the provider 104 may be provided a list of requesters 106 and their requested quantity of medicine 108, and provider 104 may choose how much medicine 108 to donate to each requester 106.

In some embodiments, MMS 102 may order, rank, or prioritized requesters 106 based on their geographic proximity to provider 104, which could both reduce shipping costs and enable quicker delivery to requester 106 prior to expiration date 105.

In some embodiments, a requester 106 may submit a request 126 for a medicine 108. The request 126 may indicate a type 128, quantity 130, receive by date (RBD) 132, and an offer 134. Type 128 may indicate a type of medicine 108, material or other composition that may be requested. The type 128 may include a brand name, a supplier, a medical name, or even a usage (e.g., sore throats, chest congestion, pain killer, fever reduction, etc.). In some embodiment, type 128 may indicate a strength of the medicine.

Quantity 130 may indicate how much of the medicine is requested. In some embodiments, MMS 102 may give priority to transactions in which the quantity of available medicine 108 is greater than or equal to the requested quantity 130. If, however, the quantity of available medicine is less than the requested quantity 130, MMS 102 may still create a match and allow requester 106 to receive a lesser quantity than then requested quantity 130, and/or piece together availability from different providers 104 sufficient to meet or more closely meet the requested quantity 130.

RBD 132 may be an optional parameter indicating a date by which the medicine 108 is needed or requested. In some embodiments, the RBD 132 may default to as soon as possible. In some embodiments, a user may indicate a specific date. In some embodiments, RBD 132 may indicate how long prior to expiration 105 the requester 106 will need to receive the medicine 108 in order to make efficient use or distribution of the medicine 108 prior to its expiration 105.

Offer 134 may indicate a price requester 106 is willing or able to pay. In some embodiments, offer 134 may indicate a request for donations if requester 106 is affiliated with a charity, low income area, or otherwise dedicated to helping indigent people.

In some embodiments, MMS 102 may generate a marketplace interface 118 (referred to herein as interface 118). Interface 118 may provide an electronic marketplace where providers 104 and requesters 106 may view and bid on provider listings 120 and requester listings 122 for possible material (medicine 108) transactions. Provider listing 120 may correspond to any listing of a medicine 108 to be made available by a provider 104, while requester listing 122 may correspond to any request 126 submitted by a requester 106 for a particular medicine 108.

In some embodiments, MMS 102 may continuously or periodically automatically match any provider listings 120 with requester listings 122 through messaging system 116. For example, if requester 106 has submitted a request 126 for a material, such as pine wood, MMS 102 may generate or log a requester listing 122. Then, for example, provider 104 may have an excess supply of pine wood, and a corresponding provider listing 120 is logged or generated. MMS 102 may identify a match, and messaging system 116 may send messages to provider 104 and requester 106 allowing them to confirm, negotiate, or reject a transaction between them for the pine wood.

In some embodiments, the match may not be an exact match, but may be a compositional match. For example, a requester listing 122 may indicate a type 128 of “Tylenol” which is a brand of medicine. Provider 104 may post that they have an access of “acetaminophen” (which is the active ingredient in “Tylenol”), and may identify a match, and send a message to requester 106 to ask if that would be an acceptable substitute for requester 106 instead of “Tylenol”. In some embodiments, tracking system 110 may be able to track the active ingredients or other ingredients in each type of listed medicine 108.

Transaction system 124 may track any resells, distributions, or donations of medicine 108 between a provider 104 and a requester 106, and update, edit, or close/remove provider listings 120 and requester listings 122 accordingly. For example, if provider listing 120 was for 100 bottles of “Tylenol” and a transaction with a requester listing 122 was for 20 bottles of “Tylenol”, then transaction system 124 may automatically close the requester listing 122 and update the quantity of the provider listing 120 to 80 bottles. In some embodiments, the lower remaining available quantity of medicine 108 may also trigger a price change in the provider listing 120. In some embodiments, tracking system 110 may request requester 106 to acknowledge or verify that the correct MID 112 was received, which may occur prior to closing the transaction in MMS 102.

In some embodiments, if provider 104 lists a medicine 108 that is not in or authenticated by tracking system 110, then MMS 102 may either reject the provider listing 120 or may flag the provider listing 120 with a visual indicator and/or message from messaging system 116 indicating that the provider listing 120 is offering unauthenticated medicine because the authenticity of the medicine 108 has not or could not be verified. In some embodiments, MMS 102 may prompt requester 106 to acknowledge their understanding of this (e.g., by clicking a checkbox or performing some other user interface functionality) before allowing a transaction to complete for any unauthenticated medicine 108 or other materials.

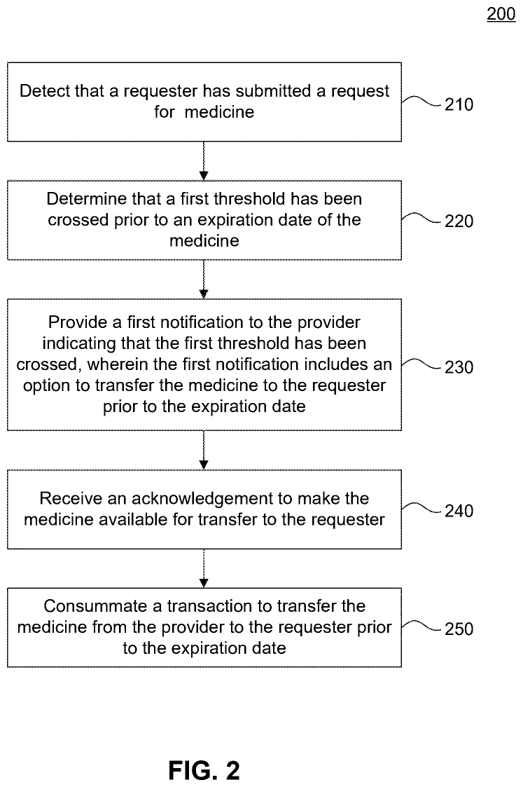

FIG. 2 is a flowchart 200 illustrating example operations for providing a medicine marketplace system (MMS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1.

In 210, it is detected that a requester has submitted a request for medicine. For example, MMS 102 may receive a request 126 from a requester 106 or identify a requester listing 122 for medicine 108 on marketplace interface 118.

In 220, it is determined that a first threshold has been crossed prior to an expiration date of the medicine. For example, MMS 102 may determine that a threshold 114 for medicine 108 has been crossed. The threshold 114 may indicate a time after which a provider 104, who may have available medicine 108 to distribute, is willing to make the medicine 108 available to a requester 106. The threshold 114 may be some date or time frame prior to expiration 105.

In 230, a first notification is provided to the provider indicating that the first threshold has been crossed, wherein the first notification includes an option to transfer the medicine to the requester prior to the expiration date. For example, messaging system 116 may provide a message or notification to provider 104 indicating that the threshold 114 has been crossed. The notification may include a list of one or more requester 106 who are seeking the medicine 108 and an option to transfer a quantity of the medicine 108 to the requesters 106, and/or an option to generate a provider listing 120 for the medicine 108 on the marketplace interface 118.

In 240, responsive to the first notification, an acknowledgement is received to make the medicine available for transfer to the requester. For example, provider 104 may send an acknowledge indicating how much of the medicine 108 to make available to each requester 106 and/or how much quantity of the medicine 108 to list, and any resale price.

In some embodiments, an acknowledgement from the provider 104 may cause MMS 102 to generate a provider listing 120 in the marketplace interface 118, which may be accessible to one or more requesters 106. A requester 106 may then select the provider listing 120 which is appropriate for them based on quantity, price, composition, and/or other features.

In 250, a transaction to transfer the medicine from the provider to the requester prior to the expiration date is consummated. For example, transaction system 124 may receive payment from a requester 106 and transfer the payment to an account of provider 104 as part of the transaction consummation. In some embodiments, MMS 102 may provide one or more authorized delivery services to deliver the medicine 108 from provider 104 to requester 106.

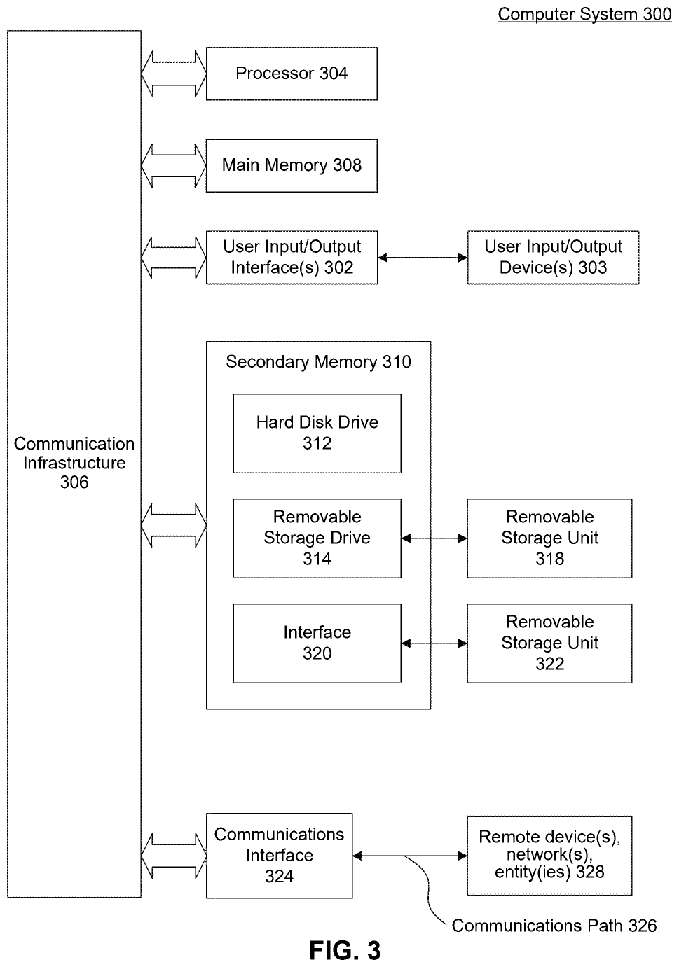

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

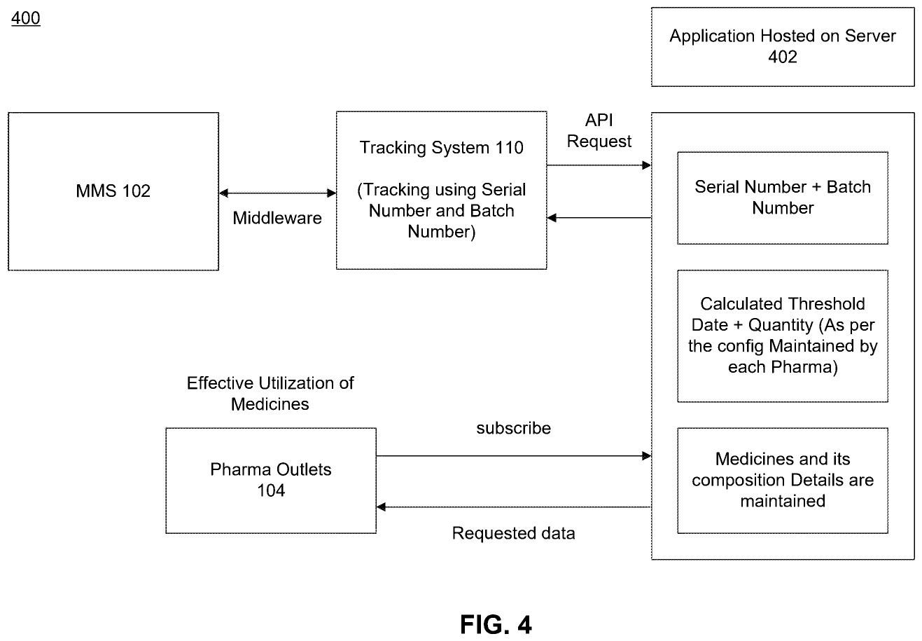

FIG. 4 is another block diagram 400 illustrating example functionality for a medicine marketplace system (MMS) 102, according to some embodiments. In the illustrated embodiment of FIG. 4, MMS 102 may communicate with tracking system 110 using any middleware. Tracking system 110 may track the medicine 108 or other materials using serial numbers and/or batch numbers of the medicine 108.

In some embodiments, tracking system 108 may communicate with an application 402 hosted on a server (such as a web server). The application 402 may communicate with both pharmacy outlets 104 (e.g., providers 104) which have subscribed to the application 402. In some embodiments, when a pharm outlet 104 has subscribed to application 402, application 402 may receive or retrieve serial and batch number information of medicine 108 stored at or purchased by the pharm outlet 104, as well as the quantity. Or, for example, application 402 may receive the serial and batch number information from tracking system 110, and may verify this with the information received from pharma outlets 104.

As described above, MMS 102 may receive or calculate a threshold 114 date by which to sell or otherwise dispose of the medicine 108. As described above, application 402 may also maintain compositions of the medicine 104, which may include various ingredients or active components in the medicine 108. In some embodiments, the composition name may include one or more other names or brands by which the medicine is known or referred.

In some embodiments, the application 402 may include some of the functionalities described herein with regard to the messaging system 116, interface 118, and transaction system 124. In some embodiments, tracking system 110 may communicate with application 402 via one or more application programming interface (APIs) requests or calls.

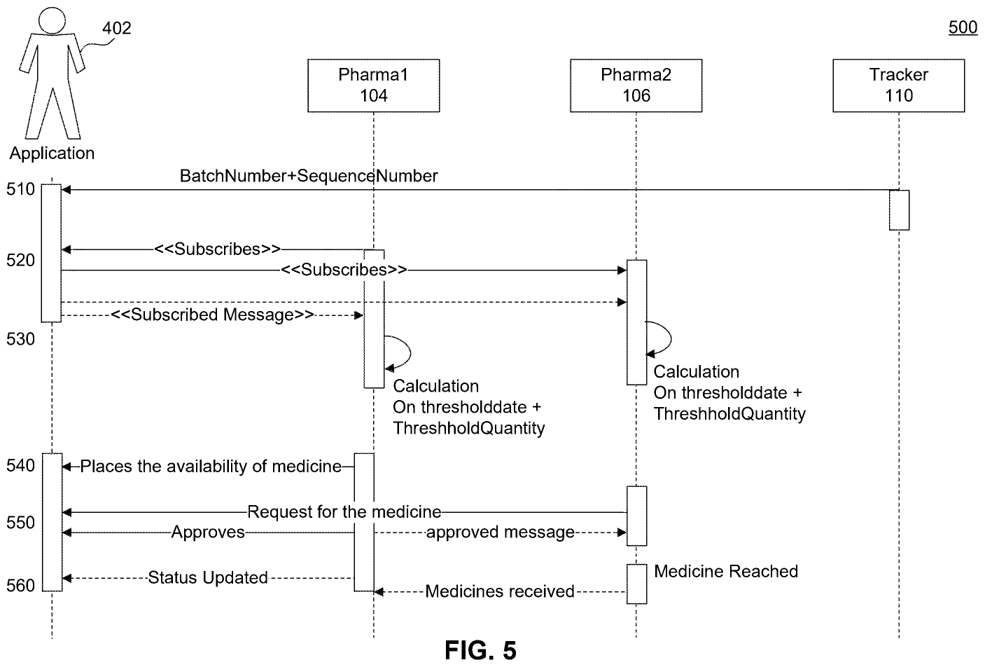

In some embodiments, application 402 may allow a warehouse manager to scan a barcode of a serialized item or serialized container to obtain information such as the decoded barcode, object type, description, status, list of medicines, batch number, composition, etc. FIG. 5 is a sequence diagram 500 illustrating example functionality for a medicine marketplace system (MMS) 102, according to some embodiments. At 510, application 402 may receive batch number and sequent number of medicines or other materials from tracker 110 (e.g., tracking system 110). At 520, both a provider 104, which may be a first pharmacy (pharma 1), and a requester 106, which may be a second pharmacy (pharma 2) may subscribe to application 402.

In some embodiments, subscribing may include setting up an account on application 402. In some embodiments, the subscriptions may include providing or confirming a listing medicine 108 with various expirations 106 that may be available for transfer at particular dates (e.g., thresholds 114), and/or requesting a particular medicine 108, as described above. At 530, and as described above, MMS 102 may calculate the threshold 114 for transferring and/or receiving a medicine 108. For example, a request 126 may include a threshold 114 by which the medicine 108 may need to be shipped or received in order to be used prior to its expiration 105.

At 540, once a threshold 114 for the supply or provider 104 of medicine has been reached, a particular quantity of the medicine 104 may be made available for transfer via the application 402 (e.g., a provider 120 may be generated and displayed via a marketplace interface 118). At 550, in some embodiments, a request 126 for the medicine 108 may be identified or submitted by pharma 2, and a transaction may be consummated between pharma 1 and pharma 2, and a confirmation or acknowledgment message may be sent to both parties.

In some embodiments, pharma 1 may then ship or transfer the medicine 108 to pharma 2. At 560, once the delivery of the proper medicine 108 (as indicate by the batch number and serial number) has been confirmed, the status of the medicine 108 may be updated on the provider listing 120. For example, the quantity of available medicine may be reduced by the amount transferred to pharma 2, or the listing may be removed or marked as sold if there is no more remaining quantity.

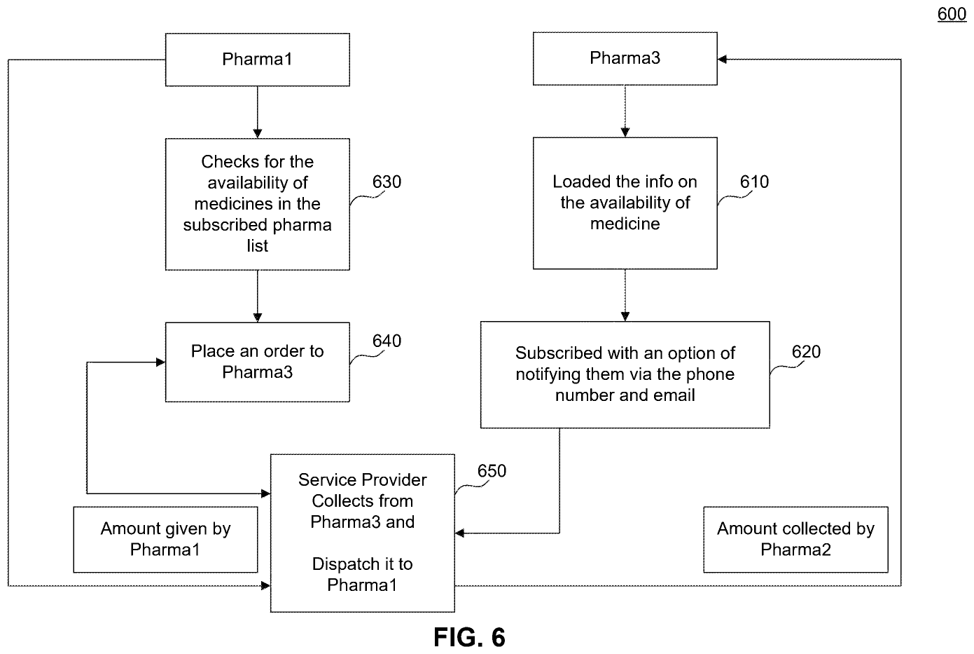

FIG. 6 is a sequence diagram 600 illustrating example functionality for a medicine marketplace system (MMS) 102, according to some embodiments. At 610, pharma 3 may create a provider listing 120 for an amount of a medicine 108 that pharma 3 is willing to sell and transfer at a particular price. At 620, pharma 3 may subscribe to receive electronic notifications when someone is interesting in purchasing the medicine 108 from their provider listing 120. The notifications may be received through text, phone messages, through an app, or other another computing system or interface.

At 630, pharma 1 may check a marketplace interface 118 for provider listings 120 to see what medicines 108 may be available for purchase/transfer. At 640, pharma 1 may place an order/request 126 for a specific quantity of medicine 108 at a specific price from pharma 3. At 650, a distribution company or service provider (e.g., transaction system 124) may collect and distribute the medicine from pharma 3 to pharma 1, and collect and distribute the money from pharma 1 to pharma 3 (less any applicable fees).

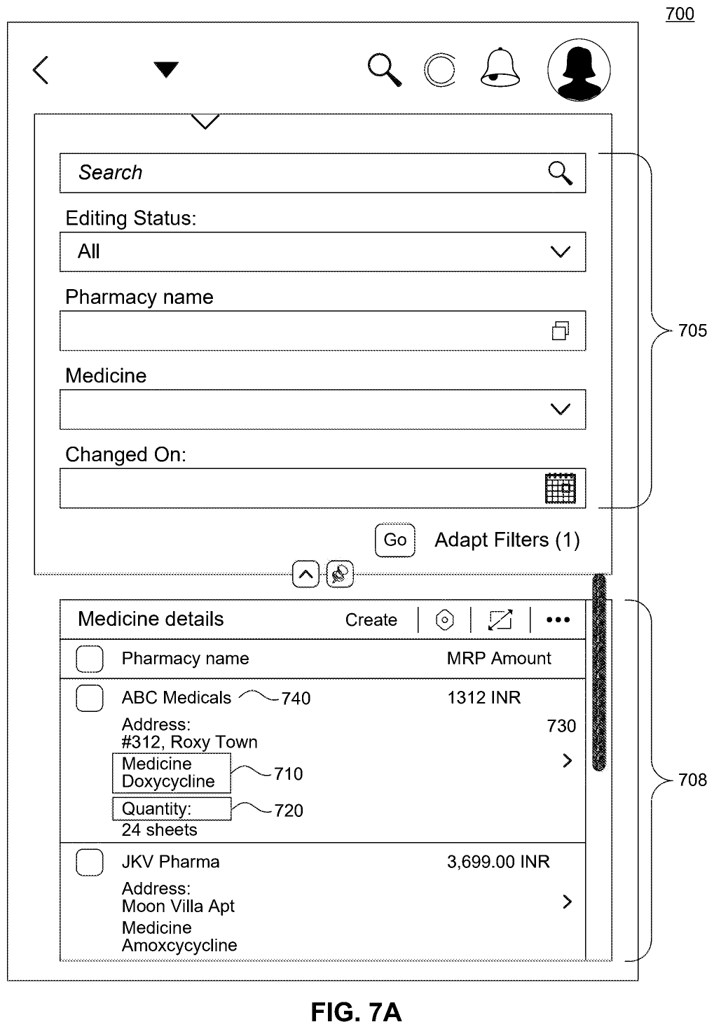

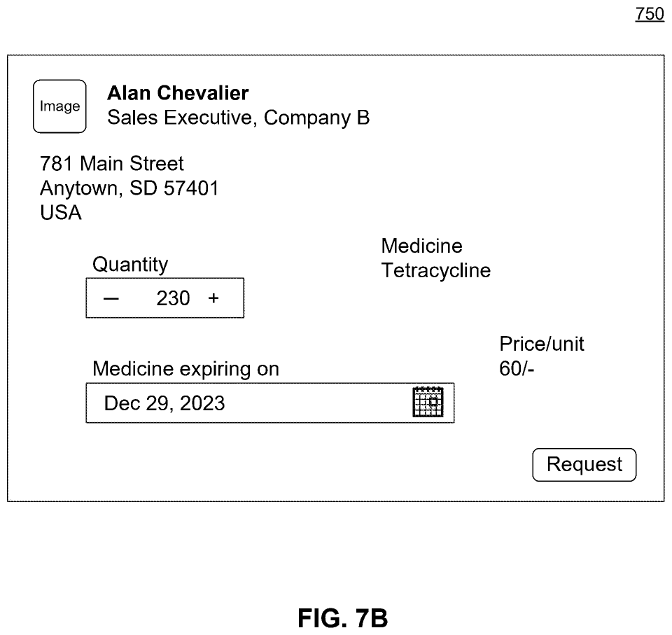

FIGS. 7A-7B are an example screens 700, 750 illustrating example functionality for a marketplace interface 118 of a medicine marketplace system (MMS) 102, according to some embodiments. The screen 700 may allow a user to enter various search criteria in any of the boxes 705. At 708, results of the searches may be displayed. The results may include information such as 710 a name of the medicine available, 720 the quantity of medicine available, 730 the price of the medicine (e.g., per unit or as a whole for the entire quantity), 740 a name and/or address or other location information of a provider 104. In some embodiments, results may also include information such as expiration 105.

Screen 750 may allow a user, such as a requester 106, to request to purchase a specific adjustable quantity of medicine (in some embodiments, the quantity may not be adjustable because the provider 104 may indicate to sell all or none of the medicine). Screen 750 may also include information about the person(s) responsible for the transfer or maintaining the medicine. In some embodiments, screen 760 may allow a user to bid a different price than the sales price illustrated for the medicine. The image may include an image of a pharmacist or sales representative, an image of the medicine, or an image of the packaging/barcode of the medicine.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
detecting, by one or more processors, that a requester has submitted a request for medicine;
determining, by the one or more processors, that a first threshold has been crossed prior to an expiration date of the medicine, wherein the medicine is available from a provider;
providing, by the one or more processors, a first notification to the provider indicating that the first threshold has been crossed, wherein the first notification includes an option to transfer the medicine to the requester prior to the expiration date;
receiving, from the provider, responsive to the first notification, an acknowledgement to make the medicine available for transfer to the requester; and
consummating, by the one or more processors, a transaction to transfer the medicine from the provider to the requester prior to the expiration date.

2. The method of claim 1, wherein the request comprises a second quantity of the medicine as requested by the requester.

3. The method of claim 2, wherein the consummating comprises:
determining that a first quantity of the medicine is greater than or equal to the second quantity of the medicine; and
receiving a transaction confirmation from both the provider and the requester to consummate the transaction.

4. The method of claim 2, wherein the consummating comprises:
receiving payment from the requester to purchase the second quantity of the medicine from the provider.

5. The method of claim 2, wherein the request comprises a deadline by which the requester requires the medicine.

6. The method of claim 2, wherein the request comprises a requester listing corresponding to the request in an electronic marketplace; and
wherein the consummating comprises generating a provider listing in the electronic marketplace, wherein the provider listing comprises a quantity of the medicine available from the provider in excess of the second quantity of the medicine.

7. The method of claim 1, wherein the one or more processors track the medicine from a manufacturer to the provider based on an identifier, wherein the identifier validates an authenticity of the medicine.

8. A system comprising:
a memory; and
at least one processor coupled to the memory and configured to perform operations comprising:
detecting that a requester has submitted a request for medicine;
determining that a first threshold has been crossed prior to an expiration date of the medicine, wherein the medicine is available from a provider;
providing a first notification to the provider indicating that the first threshold has been crossed, wherein the first notification includes an option to transfer the medicine to the requester prior to the expiration date;
receiving, responsive to the first notification, an acknowledgement to make the medicine available for transfer to the requester; and
consummating a transaction to transfer the medicine from the provider to the requester prior to the expiration date.

9. The system of claim 8, wherein the request comprises a second quantity of the medicine as requested by the requester.

10. The system of claim 9, wherein the consummating comprises:
determining that a first quantity of the medicine is greater than or equal to the second quantity of the medicine; and
receiving a transaction confirmation from both the provider and the requester to consummate the transaction.

11. The system of claim 9, wherein the consummating comprises:
receiving payment from the requester to purchase the second quantity of the medicine from the provider.

12. The system of claim 9, wherein the request comprises a deadline by which the requester requires the medicine.

13. The system of claim 9, wherein the request comprises a requester listing corresponding to the request in an electronic marketplace; and
wherein the consummating comprises generating a provider listing in the electronic marketplace, wherein the provider listing comprises a quantity of the medicine available from the provider in excess of the second quantity of the medicine.

14. The system of claim 8, wherein the at least one processor tracks the medicine from a manufacturer to the provider based on an identifier, wherein the identifier validates an authenticity of the medicine.

15. A non-transitory computer-readable medium having instructions stored thereon that, when executed by at least one computing device, cause the at least one computing device to perform operations comprising:
detecting that a requester has submitted a request for medicine;
determining that a first threshold has been crossed prior to an expiration date of the medicine, wherein the medicine is available from a provider;
providing a first notification to the provider indicating that the first threshold has been crossed, wherein the first notification includes an option to transfer the medicine to the requester prior to the expiration date;
receiving, responsive to the first notification, an acknowledgement to make the medicine available for transfer to the requester; and
consummating a transaction to transfer the medicine from the provider to the requester prior to the expiration date.

16. The non-transitory computer-readable medium of claim 15, wherein the request comprises a second quantity of the medicine as requested by the requester.

17. The non-transitory computer-readable medium of claim 16, wherein the consummating comprises:
determining that a first quantity of the medicine is greater than or equal to the second quantity of the medicine; and
receiving a transaction confirmation from both the provider and the requester to consummate the transaction.

18. The non-transitory computer-readable medium of claim 16, wherein the consummating comprises:
receiving payment from the requester to purchase the second quantity of the medicine from the provider.

19. The non-transitory computer-readable medium of claim 16, wherein the request comprises a deadline by which the requester requires the medicine.

20. The non-transitory computer-readable medium of claim 16, wherein the request comprises a requester listing corresponding to the request in an electronic marketplace; and
wherein the consummating comprises generating a provider listing in the electronic marketplace, wherein the provider listing comprises a quantity of the medicine available from the provider in excess of the second quantity of the medicine.
